(19) United States
(12) Patent Application Publication
(10) Pub. No.: US 2025/0249893 A1
(43) Pub. Date: Aug. 7, 2025

(54) OBJECT DETECTION SYSTEMS AND METHODS

(71) Applicant: Ford Global Technologies, LLC, Dearborn, MI (US)

(72) Inventors: Vivekanandh Elangovan, Canton, MI (US); Keith Weston, Canton, MI (US); John Robert Van Wiemeersch, Novi, MI (US); Joshua Wheeler, Trenton, MI (US); Sai Prasanth Velusamy, Canton, MI (US)

(73) Assignee: Ford Global Technologies, LLC, Dearborn, MI (US)

(21) Appl. No.: 18/434,172

(22) Filed: Feb. 6, 2024

(51) Int. Cl. B60W 30/09; B60W 30/095; B60W 50/12; B60W 50/14

(52) U.S. Cl. CPC B60W 30/09; B60W 30/0956; B60W 50/12; B60W 50/14; B60W 2420/54

(57) ABSTRACT

A system communicatively coupled with a vehicle is disclosed. The system may include a detection unit configured to measure sound emitted by an object, and a processor communicatively coupled with the detection unit. The processor may be configured to obtain inputs from the detection unit, and detect object presence in proximity to the first vehicle based on the inputs. The processor may be further configured to estimate at least one of an object position or an object direction relative to the first vehicle responsive to detecting the presence of the object, and control a vehicle component operation based on the estimation of at least one of the object position or the object direction. The system may be a part of the vehicle or may be part of a user device communicatively coupled to the vehicle.

### FIELD

The present disclosure relates to vehicles and more particularly to systems and methods for detecting a presence of an object in proximity to a vehicle.

### BACKGROUND

Many modern vehicles have in-built cameras and sensors to assist the operators in monitoring other vehicles/walkers in proximity to the vehicle, and to prevent adverse situations. However, in some cases, the vehicle may not be able to detect the other vehicles/walkers even with these cameras/sensors. For example, the vehicle camera/sensor may not detect another vehicle (e.g., a second vehicle) when the second vehicle may be hidden or approaching through a road corner. Similarly, the vehicle camera/sensor may not be able to detect smaller objects or walkers when the objects/walkers are not in the field of view (or in direct line of sight) of the vehicle.

Thus, there exists a need for a system and method to efficiently detect presence of other vehicles/walkers to enhance user experience and prevent adverse situations.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of a security system in accordance with the present disclosure.

FIG. 3 depicts an example scenario of object detection in accordance with the present disclosure.

FIG. 4 depicts a flow diagram of an example method for detecting an object in proximity to a vehicle in accordance with the present disclosure.

### DETAILED DESCRIPTION

### Overview

The present disclosure describes a system and method to detect an object in proximity to a first vehicle. The object may include a second vehicle, a walker, small objects such as an electric scooter, skate boards, e-bikes, and/or the like, which may not be visible to a first vehicle driver and may not be captured by vehicle cameras and/or other vehicle sensors.

The system may include a detection unit that may be configured to measure a sound emitted by the object. In some aspects, the detection unit may include ultrasonic sensors that may be configured to measure the sound in the ultrasonic frequency range. The system may further include a processor that may be configured to obtain inputs from the detection unit, detect an object presence in proximity to the vehicle based on the inputs, and perform a predetermined action based on the object presence detection. In some aspects, the system may be configured to estimate an object position and/or an object direction relative to the vehicle responsive to the object presence detection, and perform the predetermined action based on the object position and/or direction.

In some aspects, the predetermined action may include controlling a vehicle component operation based on the object presence detection and/or the estimation of the object position/direction. For example, the system may control vehicle speed, vehicle steering wheel torque, vehicle door opening and/or the like, as part of the predetermined action. In further aspects, the predetermined action may include outputting a notification to a vehicle driver via a vehicle Human-Machine Interface (HMI) to indicate the object presence in proximity to the vehicle. In further aspects, the predetermined action may include outputting a notification to the object (e.g., a user device associated with a walker) to indicate that the vehicle is in proximity to the object. In further aspects, the predetermined action may include activating a haptic feedback at a vehicle component such as a vehicle steering wheel, a vehicle door handle, and/or the like, to indicate the object presence.

In some aspects, the system may be part of the vehicle. In other aspects, the system may be part of a user device (e.g., a mobile phone, a smart watch, etc.) that may be communicatively coupled with the vehicle. When the system may be part of the vehicle, the detection unit may include ultrasonic sensors that may be in-built in the vehicle. On the other hand, when the system may be part of the user device, the detection unit may include ultrasonic sensors that may be in-built in the user device.

The present disclosure discloses a system and method that facilitates detection of objects that may be hidden and may not be visible to a vehicle driver, and may not be captured or detected by vehicle cameras or other vehicle sensors. Further, the system is configured to detect an out-of-sight object/vehicle even if the object/vehicle is not emitting sound in human hearing range (and may be emitting signals in ultrasonic range, e.g., signals emitted by ultrasonic parking sensors). Ultrasonic signals have better signal-to-noise ratio than sound in the human hearing range; therefore, the system is configured to efficiently detect out-of-sight objects/vehicles. The system may be configured to control vehicle component operation automatically to prevent any adverse situation due to the object presence in proximity to the vehicle. In addition, the system may output a notification to the vehicle driver and/or the walker to further prevent any adverse situation.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

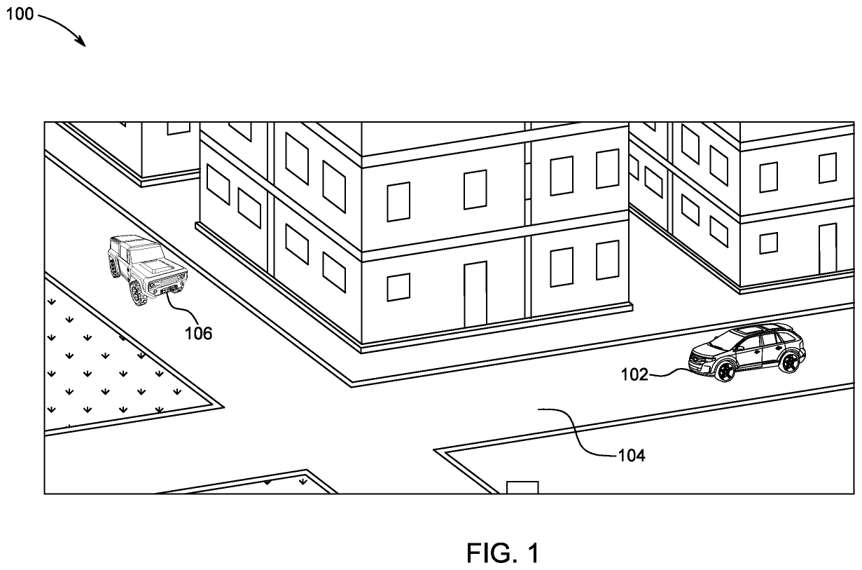

FIG. 1 depicts an example environment 100 in which techniques and structures for providing the systems and methods disclosed herein may be implemented. The environment 100 may include a vehicle 102 (e.g., a first vehicle). The vehicle 102 may take the form of any passenger or commercial vehicle such as, for example, a car, a work vehicle, a crossover vehicle, a van, a minivan, a truck, a taxi, a bus, etc. Further, the vehicle 102 may be a manually driven vehicle and/or be configured to operate in a fully autonomous (e.g., driverless) mode and/or partially autonomous mode. In some aspects, the vehicle 102 may include a traction battery or battery pack (“vehicle battery”, not shown) that may provide energy for vehicle propulsion. In other aspects, the vehicle 102 may include any other powertrain such as a gasoline engine. Although FIG. 1 depicts a four-wheeler vehicle, the present disclosure may also be applied to two-wheeler vehicles such as electric bicycles, scooters, motorcycles, etc.

The vehicle 102 may be travelling on a road network 104 that may be located in a city, a rural area, a suburb, etc. The environment 100 may further include another vehicle 106 that may be travelling on the road network 104. The vehicle 106 may be the same as or different from the vehicle 102. For example, the vehicle 106 may be an electric vehicle. In some aspects, the vehicle 106 may not be in direct line of sight or field of view (or be in the blind spot) of the vehicle 102. For example, the vehicle 106 may be hidden around a road corner, as shown in FIG. 1.

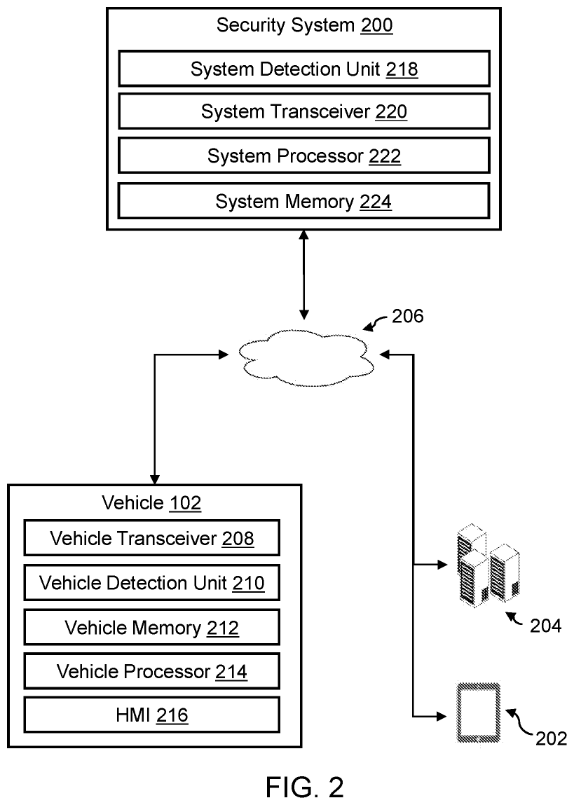

The environment 100 may further include a security system (shown as security system 200 in FIG. 2). In some aspects, the security system (“system”) may be a part of the vehicle 102. In other aspects, the system may be a part of other devices such as a user device (shown as user device 202 in FIG. 2) associated with a walker on the road network 104. The user device may include, but is not limited to, a smartphone, a smartwatch, or any wearable device. In further aspects, the system may be a part of an infrastructure including, but not limited to, a parking facility, a garage, or any other infrastructure on the road network 104. For example, the system may be a part of an Internet of Things (IoT) device around the home.

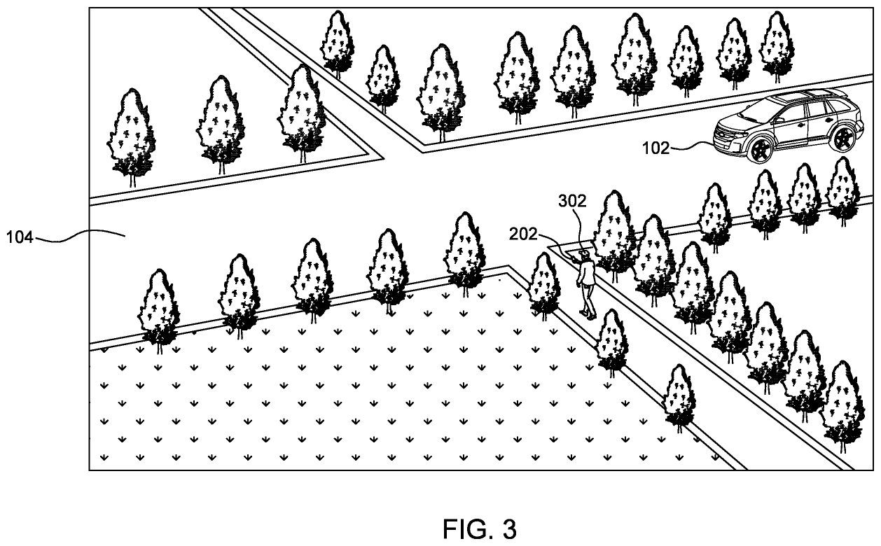

The system may include one or more ultrasonic sensors that may be configured to measure sound emitted/reflected by an object in the ultrasonic frequency range (e.g., above 20 kHz). The object may be the vehicle 106 (e.g., a second vehicle), a walker (e.g., walker 302, shown in FIG. 3), small objects such as an electric scooter, skate boards, e-bikes (not shown in FIG. 1), and/or the like.

When the system is part of the vehicle 102, the system may include ultrasonic sensors that may be in-built in the vehicle 102. The ultrasonic sensors associated with the vehicle 102 may be configured to measure sound in proximity to the vehicle 102 in the ultrasonic frequency range. For example, the ultrasonic sensors associated with the vehicle 102 may be configured to measure sound emitted by ultrasonic sensors associated with the vehicle 106. In some aspects, the ultrasonic sensors may be positioned around/on the periphery of the vehicle 102. For example, six ultrasonic sensors may be positioned in a vehicle front portion and six ultrasonic sensors may be positioned in a vehicle rear portion. In some aspects, the ultrasonic sensors may be disposed on vehicle glass and/or a vehicle rigid structure. The ultrasonic sensors may be any type of ultrasonic sensors, which may include short-range ultrasonic sensors and long-range ultrasonic sensors. Although the description above describes an aspect where the vehicle 102 includes twelve ultrasonic sensors, the present disclosure is not limited to the described aspect. The vehicle 102 may include more or a less count of ultrasonic sensors, without departing from the present disclosure scope.

The system may be configured to obtain inputs from the ultrasonic sensors and detect the object presence in proximity to the vehicle 102 based on the inputs. Stated another way, the system may be configured to detect/identify the object presence based on the sound measured by the ultrasonic sensors in the ultrasonic frequency range. Responsive to the object presence detection, the system may estimate an object position and/or an object direction relative to the vehicle 102 based on the inputs from the ultrasonic sensors, and perform a predetermined action based on the estimation.

In some aspects, the predetermined action may include outputting a first notification to a vehicle driver/operator via a vehicle Human-Machine Interface (HMI) (shown as HMI 216 in FIG. 2) or a user device associated with the vehicle driver. The notification may indicate the object presence in proximity to the vehicle 102. The notification may further include information associated with the object position and/or the object direction relative to the vehicle 102, so that the vehicle driver may accordingly maneuver vehicle movement and/or take remedial actions. For example, the system may output a notification to the vehicle driver indicating that a walker may be approaching the vehicle 102 from a vehicle right side.

In further aspects, the predetermined action may include outputting a second notification to the object to indicate the vehicle presence in proximity to the object. For example, the system may output an audible notification to the walker, via a vehicle speaker or the user device associated with the walker, to indicate the vehicle presence in proximity to the object.

In further aspects, the predetermined action may include controlling a vehicle component operation based on the estimation of the object position and/or the object direction relative to the vehicle 102. To control the vehicle component operation, in an exemplary aspect, the system may first identify a vehicle door (including tailgate and lift gate) that may face the object, and control the opening of the identified vehicle door. For example, the system may disable the vehicle door opening or enable a double-activation mode (e.g., activate a double pull mode) of the identified vehicle door, in which a vehicle user may be required to double pull/push a vehicle door handle to open the identified vehicle door. Such operations may indicate to the vehicle operator/driver that the object may be in proximity to the vehicle 102 (e.g., in proximity to the identified vehicle door).

In another exemplary aspect, the system may impede a steering wheel torque associated with a vehicle steering wheel or impede vehicle speed/movement to prevent vehicle movement towards the object, as part of the predetermined action. In further aspects, the system may activate a haptic feedback in a vehicle component (e.g., the vehicle steering wheel and/or a vehicle door handle) to indicate the object presence and/or to prevent vehicle movement towards the object.

The examples described above should not be construed as limiting, and the system may control any other vehicle component in any manner to indicate the object presence, without departing from the present disclosure scope.

When the system is part of the user device associated with the walker, the system may obtain inputs from the ultrasonic sensors (not shown) in-built in the user device. For example, when the user device may be in proximity to the vehicle 102, the ultrasonic sensors associated with the user device may measure the sound associated with the vehicle 102 in the ultrasonic frequency range. Responsive to obtaining the inputs from the ultrasonic sensors (associated with the user device), the system may identify the vehicle presence in proximity to the user device based on the inputs. The system may further estimate a vehicle position and/or a vehicle direction relative to the user device based on the obtained inputs, and may perform one or more predetermined actions. For example, the system may output a notification to the vehicle driver (e.g., via the vehicle HMI), in response to vehicle presence detection, to indicate that the walker may be in proximity to the vehicle 102. The notification may further indicate the vehicle position and/or the vehicle direction relative to the user device. In addition or alternatively, the system may output a notification to the walker via the user device, to indicate that the vehicle 102 may be in proximity to the walker.

Further system details are described below in conjunction with FIG. 2.

The vehicle 102 implements and/or performs operations, as described here in the present disclosure, in accordance with the owner manual and safety guidelines. In addition, any action taken by the vehicle driver based on recommendations or notifications provided by the vehicle 102 should comply with all the rules specific to the location and operation of the vehicle 102 (e.g., Federal, state, country, city, etc.). The recommendation or notifications, as provided by the vehicle 102, should be treated as suggestions and only followed according to any rules specific to the location and operation of the vehicle 102.

FIG. 2 depicts a block diagram of a security system 200 (or system 200) in accordance with the present disclosure. FIG. 2 will be described in conjunction with FIG. 3. In some aspects, the system 200 may be outside the vehicle 102. For example, the system 200 may be part of the infrastructure and/or a user device 202 associated with a walker. In other aspects, the system 200 may be a part of the vehicle 102.

The system 200 may be communicatively coupled with the vehicle 102, the user device 202 and one or more servers 204 (or server 204) via one or more networks 206 (or network 206). The server 204 may be part of a cloud-based computing infrastructure and may be associated with and/or include a Telematics Service Delivery Network (SDN) that provides digital data services to the vehicle 102, the infrastructure, and/or the user device 202. In some aspects, the server 204 may be configured to store information associated with ultrasonic signals associated with vehicles (such as the vehicle 102 and the vehicle 106), and/or the like. The server 204 may be configured to transmit the information described above to the vehicle 102/system 200 at a predefined frequency, or when the vehicle 102/system 200 transmits a request to the server 204 to obtain the information.

The vehicle 102 may include a plurality of units including, but not limited to, a vehicle transceiver 208, a vehicle detection unit 210, a vehicle memory 212, a vehicle processor 214, and a vehicle Human-Machine Interface 216 (HMI 216), which may be communicatively coupled with each other. The vehicle detection unit 210 may include vehicle cameras, ultrasonic sensors, Radio Detection and Ranging (radar) sensors, Light Detection and Ranging (lidar) sensors, thermal camera, and/or the like. The vehicle detection unit 210 may be configured to detect an object presence in proximity to the vehicle 102.

The HMI 216 may be configured to receive vehicle driver inputs to control vehicle operation. In addition, the HMI 216 may be configured to output one or more notifications for the vehicle driver based on inputs obtained from the vehicle detection unit 210 and/or other components or devices such as the system 200, infrastructure, the user device 202, and/or the like.

The vehicle transceiver 208 may be configured to transmit/receive signals/information/data to/from external systems and devices via the network 206. For example, the vehicle transceiver 208 may transmit information/signals/data obtained from the vehicle detection unit 210 to the system 200 via the network 206. As another example, the vehicle transceiver 208 may receive one or more notifications from the system 200 (and/or the other devices) via the network 206 and transmit the notifications to the HMI 216. As yet another example, the vehicle transceiver 208 may receive instructions (e.g., to control vehicle operation) from the system 200 and transmit the instructions to the vehicle processor 214.

The vehicle processor 214 may be disposed in communication with one or more memory devices disposed in communication with the respective computing systems (e.g., the vehicle memory 212 and/or one or more external databases not shown in FIG. 2). The vehicle processor 214 may utilize the vehicle memory 212 to store programs in code and/or to store data for performing aspects in accordance with the disclosure. The vehicle memory 212 may be a non-transitory computer-readable storage medium or memory storing a program code that enables the vehicle processor 214 to perform operations in accordance with the present disclosure. The vehicle memory 212 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The system 200 may include a system detection unit 218, a system transceiver 220, a system processor 222, and a system memory 224, which may be communicatively coupled with each other. The system transceiver 220 may be configured to transmit/receive signals/information/data to/from systems and devices including the vehicle 102 (e.g., via the vehicle transceiver 208), the user device 202, the server 204, and/or the like, via the network 206.

The system detection unit 218 may be configured to detect the object presence in proximity to the vehicle 102. In some aspects, the system detection unit 218 may include one or more ultrasonic sensors, as described above in conjunction with FIG. 1. The system detection unit 218 may measure sound in proximity to the vehicle 102 (e.g., in the ultrasonic frequency range, i.e., above 20 kHz). When the system 200 is part of the vehicle 102, the system detection unit 218 may include the ultrasonic sensors in-built in the vehicle 102. When the system 200 is part of the user device 202, the system detection unit 218 may include the ultrasonic sensors in-built in the user device 202.

The system processor 222 may be disposed in communication with one or more memory devices disposed in communication with the respective computing systems (e.g., the system memory 224 and/or one or more external databases not shown in FIG. 2). The system processor 222 may utilize the system memory 224 to store programs in code and/or to store data for performing aspects in accordance with the disclosure. The system memory 224 may be a non-transitory computer-readable storage medium or memory storing a program code that enables the system processor 222 to perform operations in accordance with the present disclosure. The system memory 224 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

As described above, in some aspects, the system 200 may be a part of the vehicle 102. In such cases, the system detection unit 218 may include the ultrasonic sensors in-built in the vehicle 102. In such scenarios, the system transceiver 220 may receive inputs from the system detection unit 218 and may transmit the inputs to the system memory 224 for storage purpose. In addition or alternatively, the system transceiver 220 may transmit the inputs to the system processor 222. The system processor 222 may obtain the inputs from the system transceiver 220 directly or from the system memory 224. Responsive to obtaining the inputs, the system processor 222 may determine/detect the object presence (such as the vehicle 106 or a walker 302 as shown in FIG. 3) in proximity to the vehicle 102 based on the inputs. For example, the system processor 222 may detect the object presence when a distance between the vehicle 102 and the object may be less than a predetermined threshold. As another example, the system processor 222 may detect that the walker 302 hidden behind the bushes (and may not be visible to the vehicle driver, vehicle camera, etc.) may be in proximity to the vehicle 102 based on the inputs obtained from the system detection unit 218.

Responsive to the object presence detection (i.e., when the distance between the vehicle 102 and the object may be less than the predetermined threshold), the system processor 222 may estimate an object position and/or an object direction relative to the vehicle 102. For example, the system processor 222 may determine if the walker 302 may be approaching from the vehicle left side or the vehicle right side. As another example, the system processor 222 may determine if the vehicle 106 (hidden behind a corner infrastructure on the road network 104) may be moving towards the vehicle 102 from a vehicle front portion.

In further aspects, the system processor 222 may be configured to control a vehicle component operation based on the estimation of the object position and/or object direction relative to the vehicle 102. For example, the system processor 222 may automatically control/impede vehicle steering torque and/or vehicle speed to prevent vehicle movement towards the object based on the estimated object position and/or object direction, responsive to detecting the object presence. As another example, the system processor 222 may control opening of a vehicle door (e.g., disabling vehicle door opening) that may face the detected object to prevent any adverse situation (e.g., to prevent vehicle contact with the object). In some aspects, the system processor 222 may identify the vehicle door that may face the object based on the estimated object position and/or direction, and may control the vehicle door opening accordingly. In further aspects, the system processor 222 may activate haptic feedback on a vehicle component such as the vehicle steering wheel to indicate to the vehicle driver about the object presence in proximity to the vehicle 102, thereby signaling to the vehicle driver to stop vehicle movement towards the object.

In further aspects, the system processor 222 may turn up sensitivity of vehicle sensor suite based on the object presence detection. For example, the system processor 222 may turn up sensitivity of radar sensors, lidar sensors, thermal camera, and/or the like (to accurately detect object position/direction), responsive to detecting the object presence. In yet another aspect, the system processor 222 may identify which vehicle is moving around the vehicle 102 responsive to detecting the object/vehicle presence in proximity to the vehicle 102. For example, the system processor 222 may obtain ultrasonic signals from different vehicles in proximity to the vehicle 102 and measure distances between the vehicle 102 and the respective vehicles based on the obtained ultrasonic signals. The system processor 222 may further determine a change in distance in real-time based on the ultrasonic signals, and identify which vehicle may be moving close to the vehicle 102 based on the change in the distance.

In further aspects, the system processor 222 may output an alert notification to the vehicle driver (via the HMI 216) and/or the walker 302 (via the user device 202 and/or a vehicle external speaker), responsive to detecting the object presence, to prevent any adverse situation. In an exemplary aspect, the system processor 222 may output the alert notification when the distance between the vehicle 102 and the object may be less than the predetermined threshold. The details associated with the notification (e.g., the first notification and the second notification) are described above in conjunction with FIG. 1. In some aspects, the first and second notifications may include information associated with the object position/direction (such as the walker 302) relative to the vehicle 102. Stated another way, the system processor 222 may output the first and second notification based on the estimation of the object position and/or the object direction. Similarly, the system processor 222 may detect presence of other small objects such as electric scooters/skate boards/e-bikes in proximity to the vehicle 102, and perform one or more predetermined actions described above.

In some aspects, the system processor 222 may be configured to calibrate noise (e.g., an external noise) to accurately detect the object presence. For example, the system processor 222 may calibrate the noise based on sounds/noises the vehicle 106 may typically emit when the vehicle 106 may be moving. In some aspects, the system processor 222 may set a threshold for noise levels typically associated with various vehicle propulsion systems/sensors/and features to help develop appropriate triggers for the ultrasonic sensor to detect the vehicle presence.

Further, as described above in conjunction with FIG. 1, the system 200 may be part of the user device 202. In such a scenario, the system detection unit 218 may include ultrasonic sensors in-built in the user device 202. In this case, the system processor 222 may obtain inputs from the ultrasonic sensors associated with the user device 202. Responsive to obtaining the inputs from the ultrasonic sensors, the system processor 222 may identify/detect vehicle presence in proximity to the user device 202 based on the obtained inputs.

In an exemplary aspect, the system processor 222 may detect the vehicle presence in proximity to the user device 202 when the distance between the user device 202 and the vehicle 102 may be less than a predetermined threshold. In further aspects, the system may estimate a vehicle position and/or a vehicle direction to the user device 202 based on the inputs obtained from the ultrasonic sensors, and may perform one or more predetermined actions. For example, the system processor 222 may output a notification to the vehicle driver (e.g., via the HMI 216), in response to vehicle presence detection in proximity to the user device 202, to indicate that the walker 302 may be in proximity to the vehicle 102. The notification may further indicate the vehicle position and/or the vehicle direction relative to the user device 202. In further aspects, the user device 202 may output a notification for the walker 302 to indicate the vehicle presence in proximity to the walker 302. As an example, the user device 202 may output a notification to the walker 302, via a user device speaker, to “STOP” when the walker 302 may be walking between parallel parked cars or between/behind bushes, and before walking into the traffic in proximity to the approaching vehicle 102, as shown in FIG. 3.

In additional aspects, the system processor 222 (associated with the vehicle 102) may obtain inputs from the system detection unit 218 and determine whether the vehicle 106 located in proximity to the vehicle 102 may be a threat for the vehicle 102, based on the obtained inputs. In this case, the system processor 222 may apply Morse code of ultrasonic sound to identify whether the vehicle 106 may be a threat for the vehicle 102. An example of such an identification is described below. The example described below should not be construed as limiting.

In an exemplary aspect, the vehicle 102 may be located inside a garage and the vehicle 106 may pull up in front of a garage door. In such cases, the system detection unit 218 may obtain ultrasonic signals from the vehicle 106, and transmit the ultrasonic signals to the system processor 222 or the system memory 224. The system processor 222 may obtain the ultrasonic signals from the system detection unit 218 and/or the system memory 224, and may compare the ultrasonic signals with pre-stored ultrasonic signals associated with the vehicle 106 (that the system processor 222 may obtain from the server 204). Based on the comparison, the system processor 222 may determine whether the vehicle 106 may be a threat to the vehicle 102 (or known to the vehicle 102). Stated another way, the system processor 222 may determine that the vehicle 106 may be a threat to the vehicle 102 based on the ultrasonic signatures associated with the vehicle 106. As an example, the system processor 222 may determine that the vehicle 106 may be a threat to the vehicle 102 when the ultrasonic signals from the vehicle 106 do not match with the pre-stored ultrasonic signals. Based on a determination that the vehicle 106 may be a threat or a “potential threat”, the system processor 222 may perform a predetermined action, such as outputting a threat notification to a user device associated with a vehicle operator, and/or control a vehicle component operation based on the determination. For example, the system processor 222 may activate a vehicle camera to capture vehicle images, and transmit the vehicle images to the system memory 224 and/or the server 204 to document/record any vehicle impairment/parking impairment.

In additional aspects, the system processor 222 may control operation (e.g., sampling) of the ultrasonic sensors (i.e., the system detection unit 218) to conserve vehicle/user device power or energy. For example, the system processor 222 may receive inputs from the ultrasonic sensors (to detect the object presence) when the ultrasonic sensors may be activated to perform other operation/sensing. In further aspects, the system processor 222 may sample the ultrasonic sensors at an acceptable rate to prevent key off-load (KOL) issues, but faster than one every 6 hours (or a predefined count of hours).

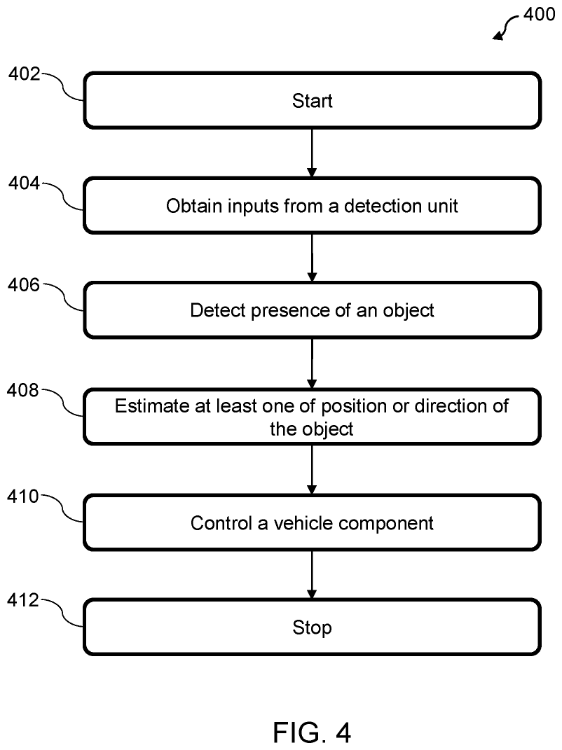

FIG. 4 depicts a flow diagram of an example method 400 for detecting an object in proximity to a vehicle in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

Referring to FIG. 4, at step 402, the method 400 may commence. At step 404, the method 400 may include obtaining, by the system processor 222, inputs from the system detection unit 218. As described above, the system detection unit 218 may include in-built ultrasonic sensors of the vehicle 102 or the in-built ultrasonic sensors of the user device 202.

At step 406, the method 400 may include detecting, by the system processor 222, a presence of an object in proximity to the vehicle 102 based on the obtained inputs. The object may be the vehicle 106 (e.g., a second vehicle), the walker 302, small objects such as electric scooters, skate boards, e-bikes (not shown in FIG. 1), and/or the like.

At step 408, the method 400 may include estimating, by the system processor 222, an object position and/or an object direction relative to the vehicle 102 responsive to the object presence detection. At step 410, the method 400 may include controlling, by the system processor 222, a vehicle component operation based on the estimation of the object position and/or the object direction. At step 412, the method 400 may end.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system communicatively coupled to a first vehicle, the system comprising:
a detection unit configured to measure a sound emitted by an object; and
a processor communicatively coupled with the detection unit, wherein the processor is configured to:
obtain inputs from the detection unit;
detect a presence of the object in proximity to the first vehicle based on the inputs;
estimate at least one of an object position or an object direction relative to the first vehicle responsive to detecting the presence of the object; and
control a vehicle component operation based on the estimation of at least one of the object position or the object direction.

2. The system of claim 1, wherein the object is a second vehicle or a person.

3. The system of claim 1, wherein the system is part of the first vehicle.

4. The system of claim 1, wherein the detection unit comprises built-in ultrasonic sensors in the first vehicle.

5. The system of claim 1, wherein the system is part of at least one of a mobile device or a smart watch.

6. The system of claim 1, wherein the processor is further configured to output a first notification on a first vehicle Human-Machine Interface (HMI) or a mobile device based on the estimation of at least one of the object position or the object direction.

7. The system of claim 1, wherein the processor is further configured to output a second notification to the object based on the estimation of at least one of the object position or the object direction.

8. The system of claim 7, wherein the second notification comprises an audible notification.

9. The system of claim 1, wherein the processor controls the vehicle component operation by activating a haptic feedback in a vehicle steering wheel to prevent vehicle movement towards the object.

10. The system of claim 1, wherein the processor controls the vehicle component operation by impeding a steering wheel torque associated with a vehicle steering wheel or impeding vehicle speed to prevent vehicle movement towards the object.

11. The system of claim 1, wherein the processor controls the vehicle component operation by identifying a vehicle door that faces the object based on the estimation of at least one of the object position or the object direction, and disabling vehicle door opening.

12. The system of claim 1, wherein the processor controls the vehicle component operation by identifying a vehicle door that faces the object based on the estimation of at least one of the object position or the object direction, and enabling a double activation mode of the vehicle door.

13. The system of claim 1, wherein the processor is further configured to:
determine that the object is a threat for the first vehicle based on the inputs, wherein the inputs comprise ultrasonic signature of the object; and
control the vehicle component operation based on the determination.

14. The system of claim 13, wherein the processor controls the vehicle component operation by activating a vehicle camera.

15. A method comprising:
obtaining, by a processor, inputs from a detection unit, wherein the detection unit is configured to measure a sound emitted by an object;
determining, by the processor, a presence of the object in proximity to a vehicle based on the inputs;
estimating, by the processor, at least one of an object position or an object direction relative to the vehicle responsive to determining the presence of the object; and
controlling, by the processor, a vehicle component operation based on the estimation of at least one of the object position or the object direction.

16. The method of claim 15, wherein the object is a second vehicle or a person.

17. The method of claim 15, wherein controlling the vehicle component operation comprises impeding a steering wheel torque associated with a vehicle steering wheel or impeding vehicle speed to prevent vehicle movement towards the object.

18. The method of claim 15, wherein controlling the vehicle component operation comprises:
identifying a vehicle door that faces the object based on the estimation of at least one of the object position or the object direction; and
disabling vehicle door opening.

19. The method of claim 15, wherein controlling the vehicle component operation comprises:
identifying a vehicle door that faces the object based on the estimation of at least one of the object position or the object direction; and
enabling a double activation mode of the vehicle door.

20. A non-transitory computer-readable storage medium in a distributed computing system, the non-transitory computer-readable storage medium having instructions stored thereupon which, when executed by a processor, cause the processor to:
obtain inputs from a detection unit, wherein the detection unit is configured to measure a sound emitted by an object;
detect a presence of the object in proximity to a vehicle based on the inputs;
estimate at least one of an object position or an object direction relative to the vehicle responsive to detecting the presence of the object; and
control a vehicle component operation based on the estimation of at least one of the object position or the object direction.
